(19) United States
(12) Patent Application Publication
(10) Pub. No.: US 2004/0059661 A1
(43) Pub. Date: Mar. 25, 2004

(54) System for displaying a portfolio

(76) Inventors: Wolfgang Arndt, Langenfeld (DE); Heinz-Josef Hilden, Koln (DE); Norbert Pourie, Koln (DE); Roseli Steinbock, Leverkusen (DE)

Correspondence Address: BAYER POLYMERS LLC, 100 BAYER ROAD, PITTSBURGH, PA, 15205, US

(21) Appl. No.: 10/601,516

(22) Filed: Jun. 23, 2003

(30) Foreign Application Priority Data
Jun. 25, 2002 (DE) 10228262.5

(51) Int. Cl. G06F 17/60

(52) U.S. Cl. 705/36

(57) ABSTRACT

The invention concerns a system for displaying a portfolio comprising a computer-legible data memory with a database system. In the database system are stored basic objects, each of which is clearly linked to one or more basic data. The basic objects are allocated to one or more structural units in a multi-dimensional hierarchical model of a company or an institution. The structural units are stored in a relational database. The basic objects allocated to the individual structural units can be displayed with one or more basic data selectively or as a whole. The basic data can be patent applications/patents, contracts or products.

The invention concerns a system for displaying a portfolio taking into account the structural units of the company or an institution which are shown in a multidimensional hierarchical model of the company or institution.

In decentrally organised companies or institutions it is advantageous if the various portfolios such as patent portfolio, contract portfolio or product portfolio, which must be allocated to the company divisions or organisational units, can be displayed centrally and made accessible outside the company division or organisational unit. This display allows the taking of central strategic decisions and ensures effective collision control.

The object of the invention is to create a possibility of displaying the portfolios present decentrally in a company division or organisational unit of the company or institution.

To achieve the object of the invention, a system for displaying a portfolio comprises a computer-legible data memory with a database system. In the database system are stored basic objects, each of which is clearly linked with one or more basic data. The basic objects are one or more structural units in a multi-dimensional hierarchical model of the company or institution. The structural units are stored in a relational database. The basic objects allocated to the individual structural units can be displayed selectively or together with one or more basic data.

It may be the case that not all users of a database system according to the invention should have access to all basic objects with their basic data. In this case one or more users can be stored in the database system and each allocated to one or more of the stored structural units. These users can only display selectively basic objects which belong to the structural units allocated to these users.

A basic object can be linked with one or more other basic objects.

Various basic objects can be linked to the same basic datum.

The basic objects can for example be patent applications/patents, contracts or products.

If the basic objects are patent applications/patents, the basic data can be bibliographic data on the patent applications/patents such as priority dates, countries in which applications have been made, and for these countries the application number and date, publication number and date, granting number and date, due date for patent fees, durations, patent expiry dates, examination request dates, information on whether objections or appeals have been submitted, cancellation date, applicant and/or inventor. Other basic data on patent applications/patents can be information on the organisation and charging of activities to patent applications/patents within the company or institution, as decision bodies and their resolutions, internal decision dates, products for which inventor royalties are paid, accounts for charging of costs, competent patent attorney or agent and/or status of the entire patent family (in force, expired, lapsed).

If the basic objects are contracts, the basic data can for example comprise the following: contract type, licence type, contract partner, supplier/client, contract start, contract end, signature dates, object of the contract, contract status (e.g. in force, terminated), contract language, countries concerned.

If the basic objects are products, the basic data can be data on the products such as turnover or profit.

The basic data can be hierarchy-dependent or hierarchy-independent. Hierarchy-dependent basic data are displayed dependent on the basic objects, linked to the structural unit for which the basic objects themselves are displayed. If the hierarchy-dependent basic data are e.g. sensitive company data of a first holding company in the economic structure, and a basic object e.g. is allocated to several holding companies at the same time, the hierarchy-dependent basic data can only be displayed if the basic object is retrieved via the structural unit allocated to the first holding company.

Hierarchy-independent basic data however can always be displayed irrespective of the allocated structural unit if the allocated basic object is displayed.

The multi-dimensional hierarchical model can reflect for example firstly a science/technology-based structure and secondly an economics-based structure of the company or institution. The science/technology-based structure can entail structuring by particular product groups, applications or areas of use, indications, research fields etc. The economics-based structure can entail structuring by national and/or international holding companies or partners in a company or institution and/or structuring by managerial organisational units such as Purchasing, Marketing, Production etc.

The computer-legible data memory is preferably located in a central computer connected with one or more user terminals. The user terminals have at least one input device and a display device to display the selected basic objects and are connected with the central computer such that data can be exchanged electronically between the central computer and the user terminals.

### FIGURES AND EXAMPLES

These show

FIG. 1 Client/server system architecture

FIG. 2 Citrix-Server system architecture

FIG. 3 Extract of the data model for hierarchy-dependent data

FIG. 4 Display of a hierarchical data structure, specific to a structural unit, with allocated basic objects

FIG. 5 Display of hierarchy-dependent basic data

FIG. 6 Display of hierarchy-independent basic data

FIG. 7 Extract of the data model for patents as basic objects

FIG. 8 Extract of the data model for contracts as basic objects

FIG. 9 Display of a selection of patents as basic objects

FIG. 10 Drill-down menu for basic object Patent

FIG. 11 Display of drill-down target “Countries”

FIG. 12 Display of drill-down target “Inventor”

FIG. 13 Display of selection of patents as basic objects with a particular inventor

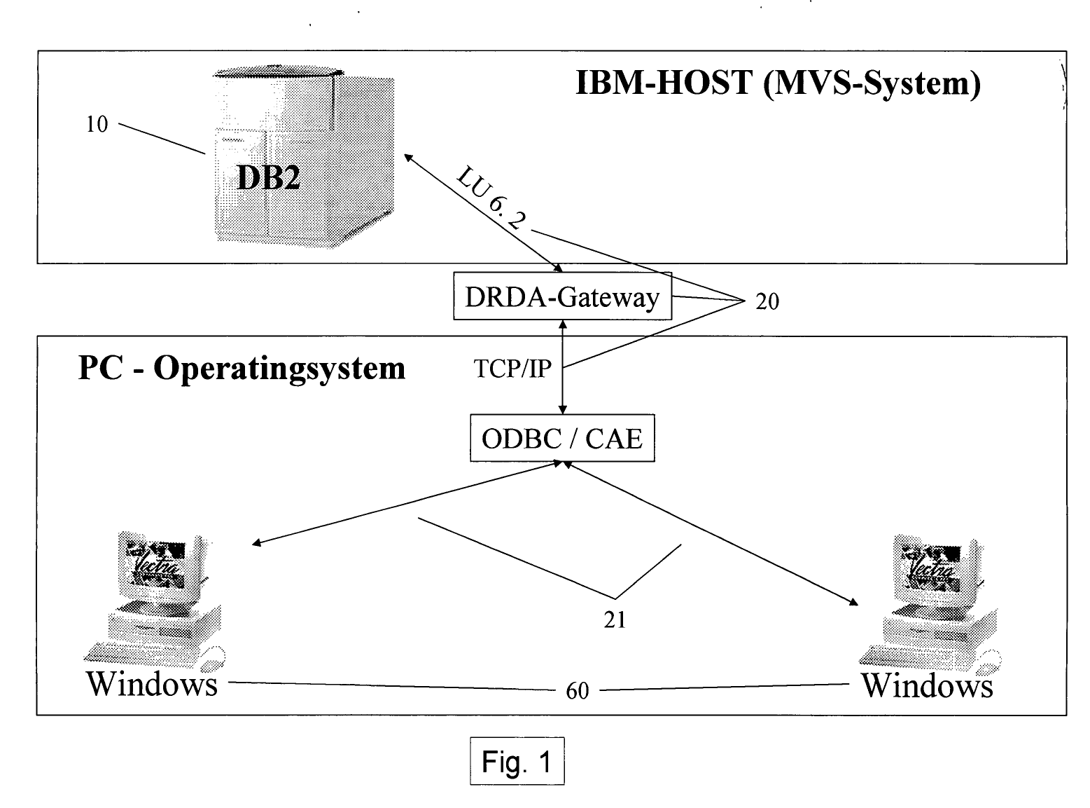

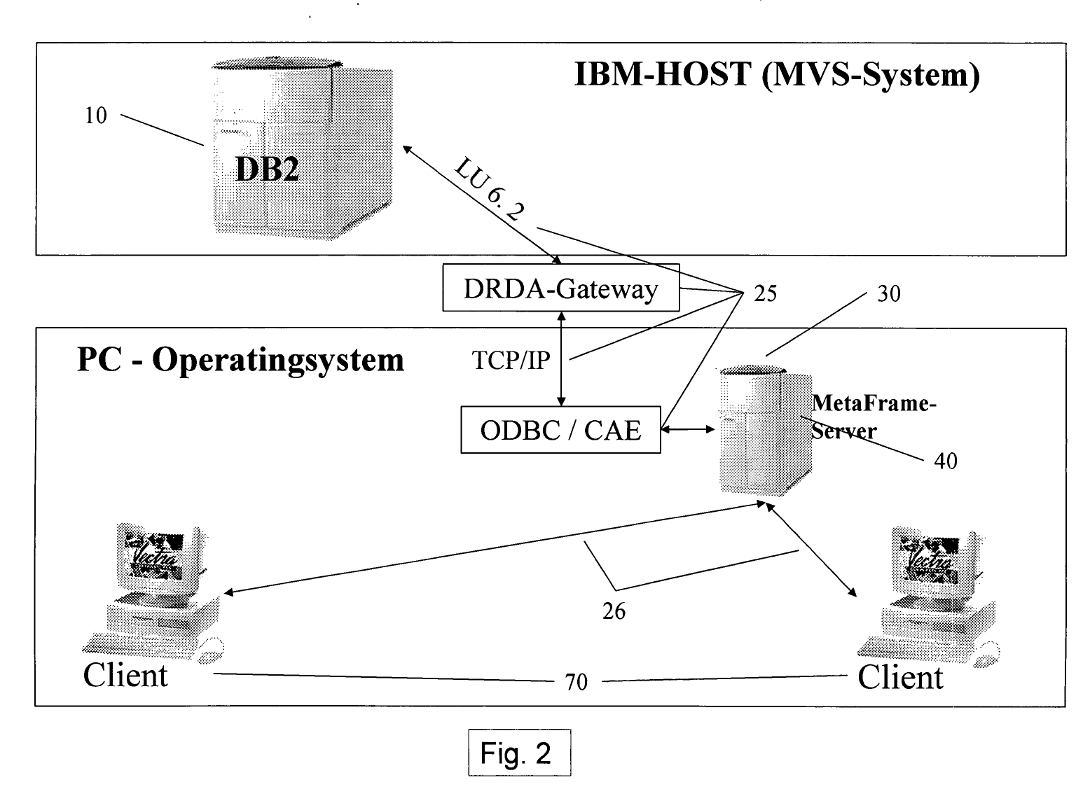

FIGS. 1 and 2 show in which network environment the system according to the invention can be used.

FIG. 1 shows a HOST computer (MVS computer) with a database system DB2 10, a communication network 20 and 21, and the user terminals 60.

The database HOST computer 10 prepares the database system DB2 with the basic objects, basic data, structural data and links stored according to the invention.

The database HOST computer 10 is linked via a communication network 20 and 21, e.g. an Ethernet, with the user terminals 60. The user terminals 60 are modem computers with the inSight® software by Arcplan GmbH and application datasheets which are programmed according to the present invention.

The user terminals are equipped with a local data memory, a display device to display data and a keyboard or other input device (e.g. mouse) for entering information.

FIG. 2 shows a database HOST computer (MVS computer) with the database system DB2 10, a communication network 25 and 26, a further server 30 with a computer-legible data memory 40 and the user terminals 70.

The database HOST computer 10 prepares the database system DB 2 with the basic objects, basic data, structural data and links stored according to the invention. The database HOST computer 10 is linked via a communication network 25 e.g. an Ethernet, to a server 30 with multi-user capacity.

The server 30 is a modem multi-user computer, programmed so that it can execute the software insight® by Arcplan GmbH with the corresponding application datasheets of the present invention, for several users in parallel.

Server 30 is connected to a computer-legible data memory 40. The server 30 is also linked via a communication network 26 e.g. an Ethernet, with the user terminals 70 described above.

Server 30 is programmed so that it can receive the commands from the user terminals 70, access the data in the database HOST computer 10, process the acquired data and pass the resulting display to the user terminals 70 so that it can be displayed on the display device of the user terminals 70.

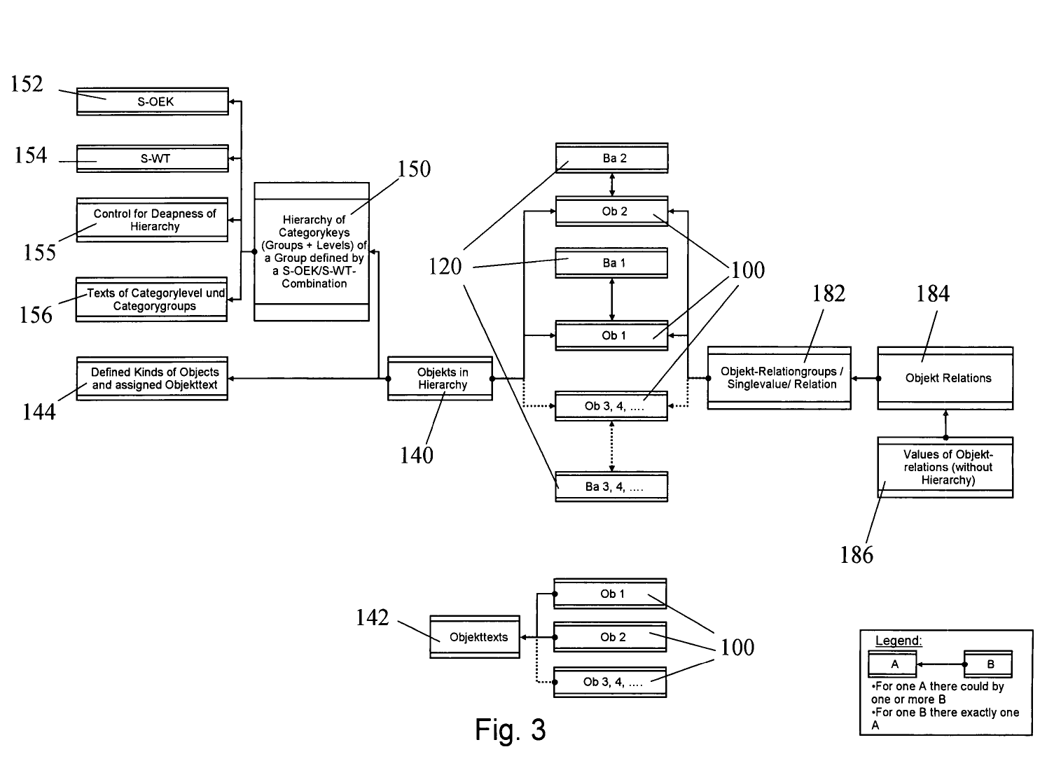

FIGS. 3 to 5 show various aspects of an example data model according to which the basic objects are allocated to the structural units in a multi-dimensional hierarchical model of the company or institution and linked with the basis data. An arrow between the different boxes means a single allocation in the direction of the arrow and a multiple allocation in the opposite direction to the arrow. The boxes essentially represent tables via which the corresponding objects/data are linked together.

FIG. 3 shows an extract from an example data model for the hierarchy-dependent data.

In the centre of the data model are the basic objects Ob1, Ob2, Ob3, Ob4 . . . 100.

The left-hand part of FIG. 3 shows the allocation of basic objects to the structural units. The right-hand part of FIG. 3 shows the allocation of hierarchy-dependent basic data to the basic objects.

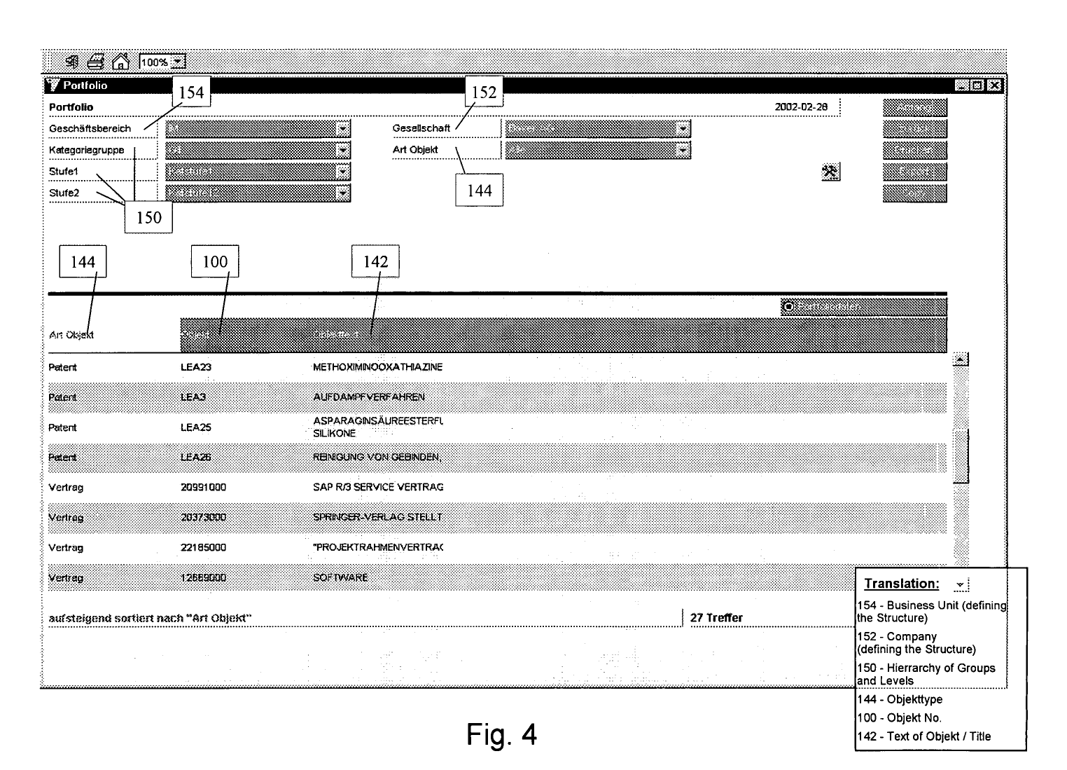

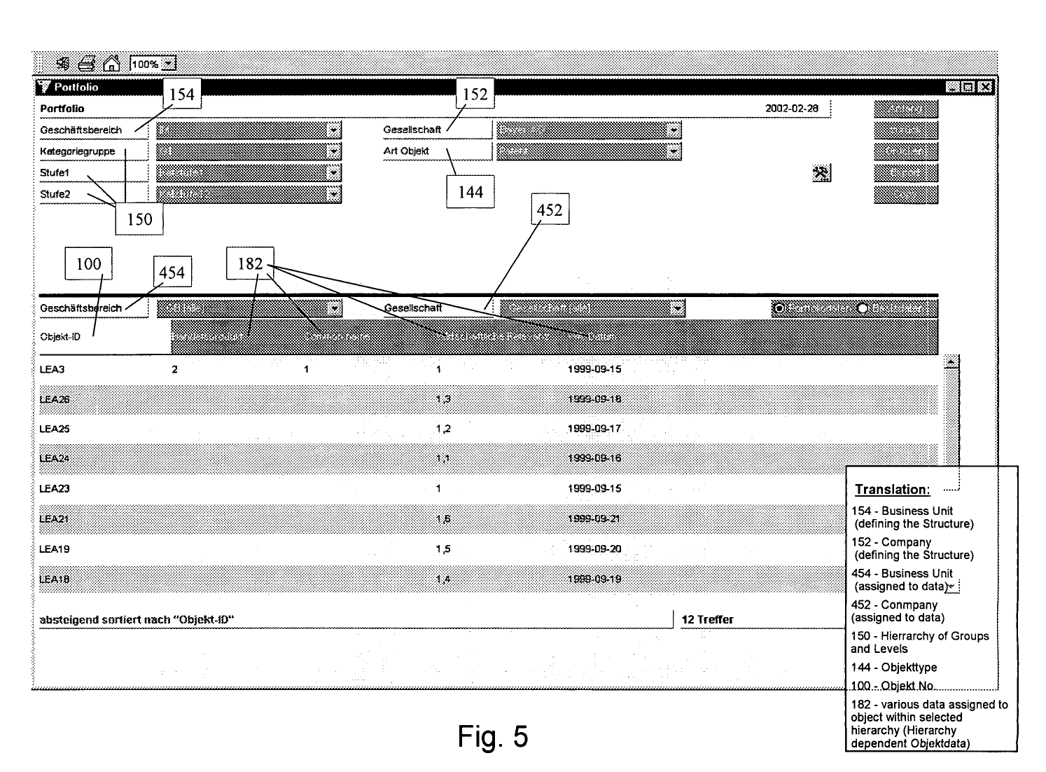

Also each basic object 100 is linked with hierarchy-independent basic data (Ba1, Ba2 . . . ) 120, the structuring of which is shown in FIGS. 4 and 5 as examples for the basic object types Patent application/patents and Contracts.

Each basic object 100 is linked via linking table 140 with one or more structural units of a hierarchical structure according to economic and scientific/technical aspects. The highest hierarchical level of the structure contains structural units according to economic aspects, e.g. the companies of a group S-OEK 152, and structural units according to scientific/technical aspects S-WT 154, e.g. a technology, next to each other with equal value. In the hierarchy level below are combinations of S-OEK and S-WT. Allocated to each of these combinations of S-OEK and S-WT in the next hierarchical level are one or more groups (e.g. Marketing, Research, Purchasing, Technology XY . . . ) which can be selected by scientific/technical or economic criteria. Then further hierarchy levels follow with steps up to any depth, which represent a further science/technology-based structuring or structuring by economic criteria.

This hierarchical structuring (S-OEK/S-WT, Group, Step 1, Step 2, . . . ) is stored in 150. 155 contains information on the maximum depth of the hierarchy in each group, and 156 the encoding of the group and step titles. The maximum depth of hierarchy 155 ensures the correct control of the display in the display device of the user terminal.

Each base object 100 is also linked in its hierarchy allocation in a code table 144 to the type of basic object (Patent applications/patents, Contracts . . . ).

By allocating the basic objects 100 to the structural units in the hierarchy levels 140, when one of the structural units 140 is selected in any hierarchy level, all basic objects 100 allocated to this structural unit can be displayed.

Irrespective of their nature, all basic objects 100 are linked in a table 142 to a descriptive text. The redundant storage of basic object texts e.g. the title of the patent application/contract in table 142, allows a search for basic objects 100 outside object types without first defining a basic object type 144.

182 contains hierarchy-dependent basic data linked with the basic objects 100. Irrespective of which structural unit is used to display the basic objects 100, the hierarchy-dependent basic data 182 belonging to the basic objects 100 can be displayed. If the hierarchy-dependent basic data 182 is e.g. sensitive company data of a company S-OEK-1, and a basic object 100 is allocated e.g. to various companies S-OEK-1 and S-OEK-2 simultaneously, the hierarchy-dependent basic data 182 can only be displayed if the basic object 100 is retrieved via a structural unit allocated to S-OEK-1.

The hierarchy-dependent basic data 182 allocated to the basic objects 100 can be individual values e.g. an evaluation factor, or an entire relation e.g. a list of products. Individual values are stored directly in the object-relation groups 182. Relations are stored in the object relations 184, i.e. here for example it shows which products the list contains.

In addition, for the object relations 184 (e.g. for the products), amounts (186) can be stored which are stored independently of the hierarchy via the identification number of the object relations.

FIG. 4 shows the display of a hierarchical data structure 150 specific to a structural unit, together with the basic objects 100 allocated to this data structure according to FIG. 3.

To restrict the quantity of results of a user-defined search, as well as the selective choice by combinations 152 S-WT (company) and 154 S-OEK (company division), the hierarchical structure (150, groups and steps of this group) and the object type 144 are used as selection criteria. In FIG. 4, for S-OEK “IM” and S-WT “Bayer AG”, as hierarchical structure “G1”/“Katstufel”/“Katstufe12” was selected. For the object type, no restriction was made (All).

After restriction to a particular object type 144, die hierarchy-dependent basic data 182 for the objects 100 listed can be shown (see FIG. 5).

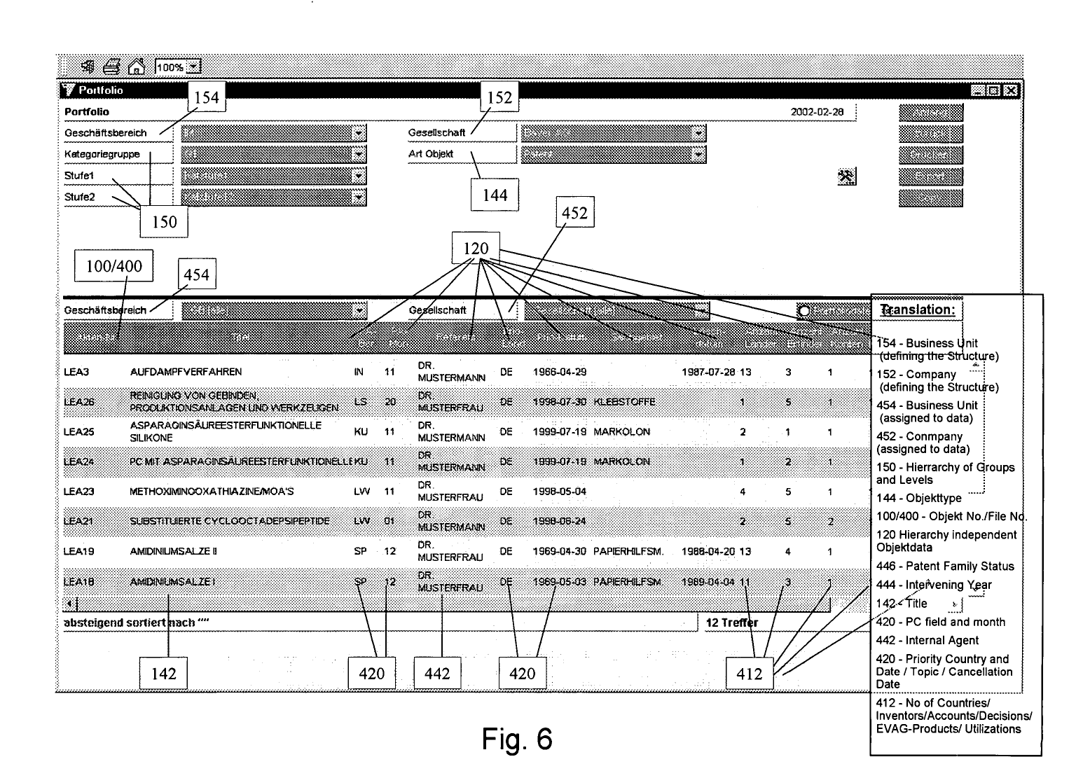

FIG. 5 shows the display of the hierarchy-dependent basic data 182 from FIG. 3. Via further drill-downs any hierarchy-dependent object relations 184 and their amounts 186 can be displayed. Also at this point it is possible to display directly the hierarchy-independent basic data 120 (from FIG. 3) of the objects shown (display in FIG. 6).

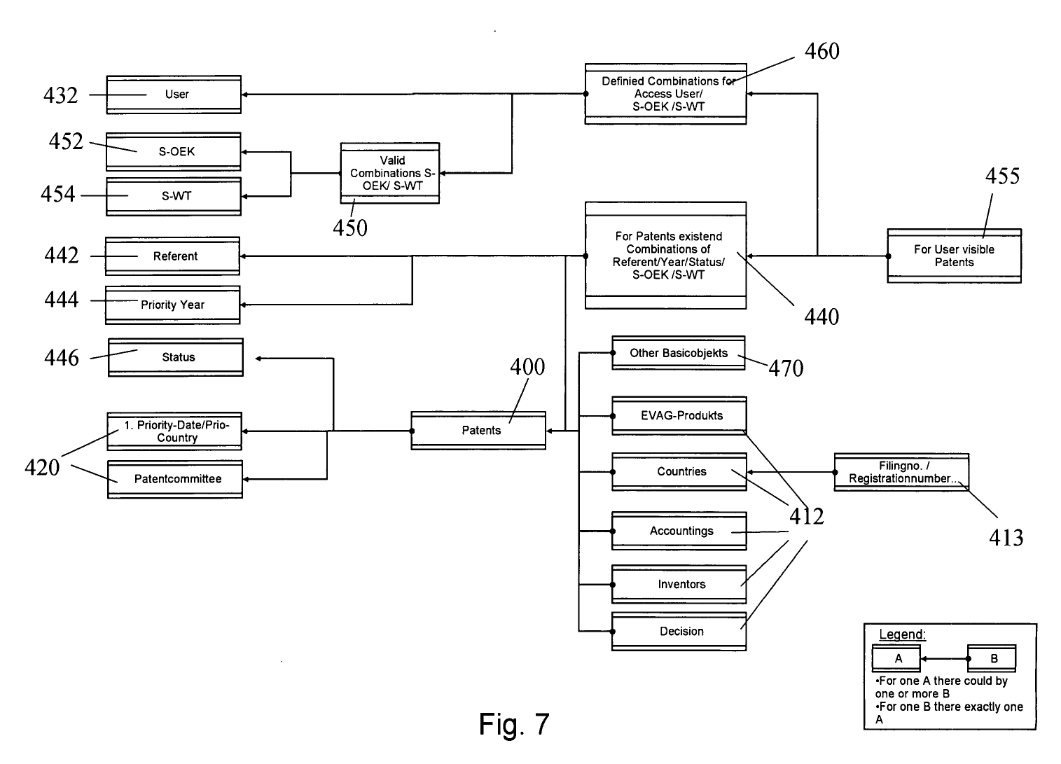

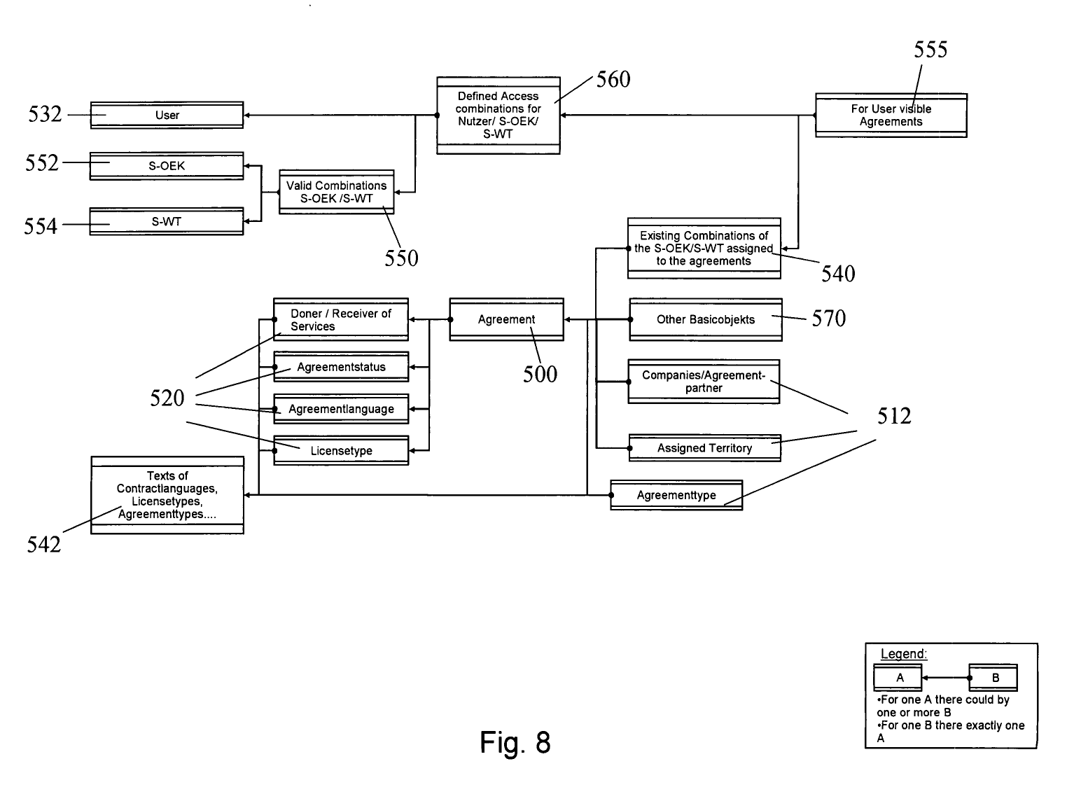

If the object type 144 is the object type of a basic objects Patent (400, FIG. 7) or Contract (500, FIG. 8), as well as the hierarchy-dependent basic data (120, FIG. 3) also the hierarchy-independent basic data 412, 413, 420, 442, 444, 446 (FIG. 7) or 512, 520, 542 (FIG. 8) can be displayed. One example of this is given in FIG. 6 for basic object type Patent.

FIG. 6 shows the display of the hierarchy-independent basic data 120 from FIG. 3 for the basic object type Patent. For each basic object 100 according to FIG. 7 information is displayed on the patent committee 420, the agent 442, the country and date of priority and on EVAG products (=products for which inventor royalties are paid), countries, accounts, inventors and decisions 412. Also an object text (title) 142 (FIG. 3) is shown in each case.

FIG. 7 shows as an example in the lower area a structure of the hierarchy-independent basic data (Ba1, Ba2, . . . ) 120 from FIG. 3 for the basic object type Patent applications/patents 400, and in the upper area the implementation of a selective display entitlement 460 for basic objects 400 for various users.

A plurality of hierarchy-independent basic data 412, 413, 420, 442, 444, 446 are allocated to the basic object Patent application/patent 400. Some of these hierarchy-independent basic data 412, 420, 442, 444, 446 are present as code lists in selection menus and can be used to restrict the quantity of results of a user-defined search for the basic object type Patent applications/patents. FIG. 7 shows as an example some hierarchy-independent basic data.

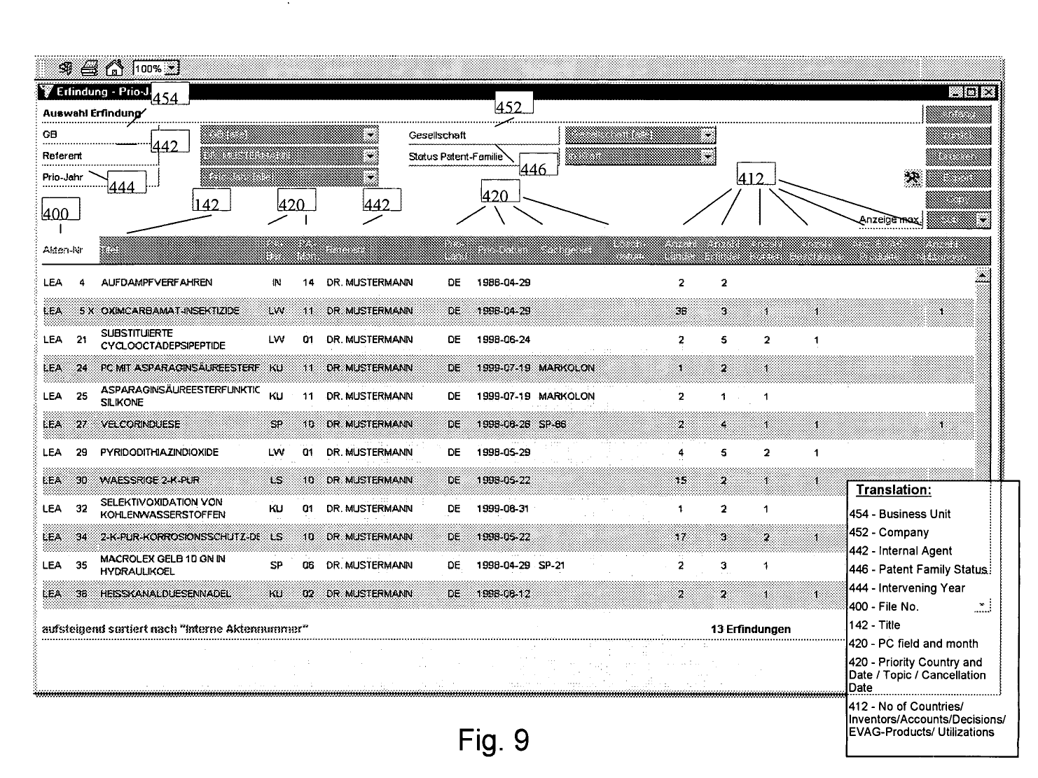

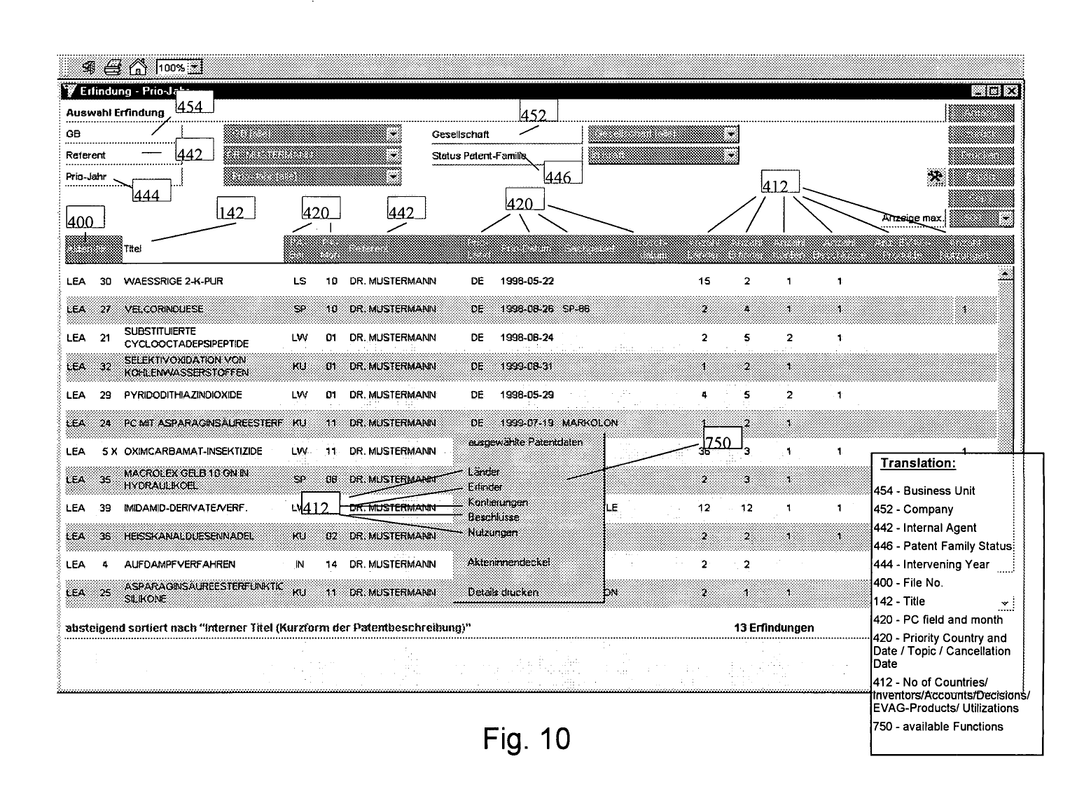

These hierarchy-independent basic data differ according to whether a single basic datum or more than one of the type described in the corresponding boxes are allocated to a basic object Patent applications/patents 400. A single basic datum is allocated to each basic object Patent applications/patents 400 for the basic data 420 “1st priority date and country of priority application”, “Patent committee area/month of meeting”, 444 year of priority, 446 “Status” (in force, expired, lapsed, . . . ), 442 agent. Further such basic data are the cancellation date of the entire patent family and the specialist area allocation in the patent committee (FIGS. 9 and 10).

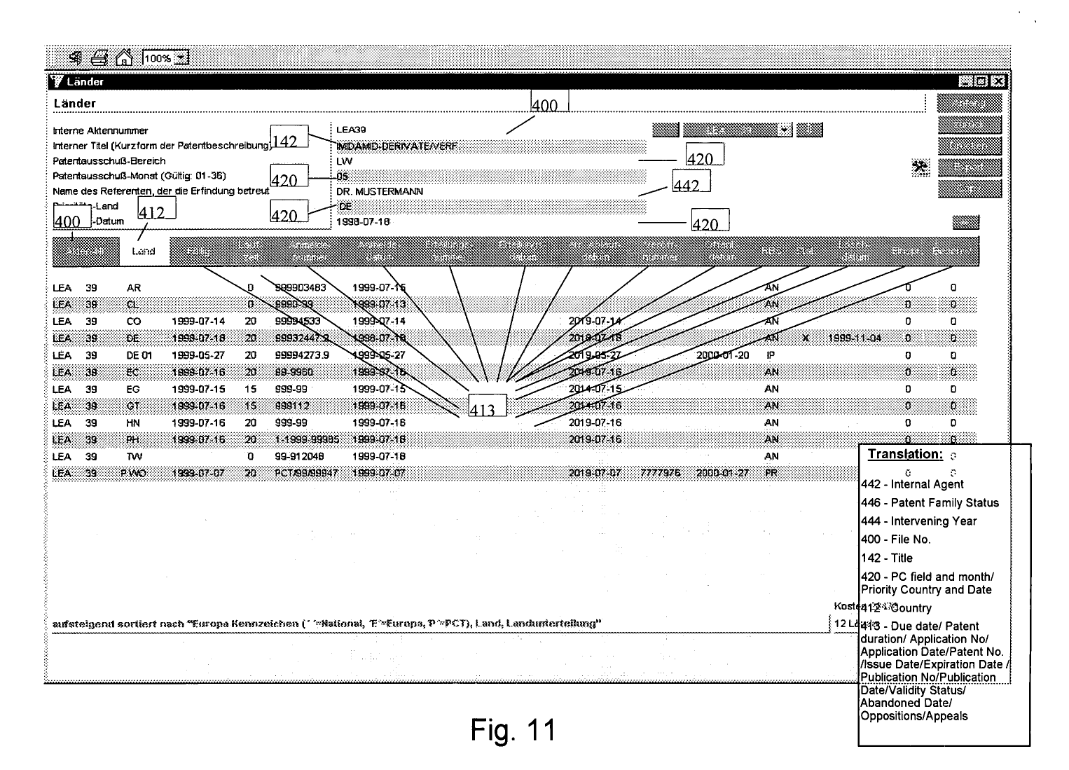

Several basic data can also be allocated to each basic object Patent applications/patents 400 for the basic data 412 “Products for which inventor royalty is paid”, “Countries”, “Accounts”, “Inventor”, “Decisions of Patent Committee”. Allocated to the countries can then be the basic data 413 “Due date for patent fees”, “Patent duration”, “Application number and date”, “Granting number and date”, “Patent expiry dates”, “Publication number and date”, “Status of granting process” (Application, examination request, patent), “Country status” (X=cancelled, F=due), “Cancellation date”, information on whether oppositions or appeals have been submitted, and the cancellation date (FIG. 11).

470 shows which other basic objects (e.g. contracts) are linked with the patent application/patent 400.

The top part of FIG. 7 shows the access possibilities for users 432 as a function of the structural units of the highest hierarchy level S-OEK 452 and S-WT 454. Table 450 gives the valid structural units which result from combinations of S-OEK 452 and SWT 454. Only users 432 allocated to the individual combinations of S-OEK 452 and S-WT 454 in Table 450 can display the basic objects 400 which are allocated to the structural units corresponding to the same combination of S-OEK and S-WT.

The basic objects actually displayed for the individual users in 455 arise from the intersection of basic objects from 460 and the basic objects present in 440 as a combination of basic objects with a particular processor 442, a priority year count 444 and the status with particular S-OEK and S-WT.

FIG. 8 shows as an example in the lower area a structuring of hierarchy-independent basic data (Ba1, Ba2, . . . ) 120 from FIG. 3 for the basic object type Contract 500 and in the upper area the implementation of a selective display entitlement of the basic objects 500 for various users.

A plurality of hierarchy-independent basic data 512, 520 are allocated to the basic object Contract 500. These hierarchy-independent basic data are present as code lists in selection menus and can be used to restrict the quantity of results of a user-defined search. FIG. 8 shows as an example some hierarchy-independent basic data.

These hierarchy-independent basic data differ by whether a single basic datum or more than one of the type described in the corresponding boxes are allocated to a basic object Contract 500. A single basic datum is allocated to each basic object Contract 500 for the basic data 520 “Supplier/client”, “Contract status”, “Contract language”, “Licence type”.

Lists of basic data can also be allocated to each basic object Contract 500 for the basic data 512 “Companies/contacts”, “Countries concerned” or “Contract type”.

570 shows which other basic objects (e.g. patents) are linked with the contract 500.

The top part of FIG. 8 shows the access possibilities for users 532 as a function of the structural units of the highest hierarchy level S-OEK 552 and S-WT 554. Table 550 shows the valid structural units which result from combinations of S-OEK 552 and S-WT 554. Only users 532 allocated to the individual combinations of S-OEK 552 and S-WT 554 in Table 550 can display the basic objects 500 which are allocated to the structural units corresponding to the same combination of S-OEK and S-WT.

The basic objects actually displayed for the user in 555 arise from the intersection of basic objects from 560 and the basic objects present in 540 as a particular combination of S-OEK 552 and S-WT 554.

FIGS. 9 to 13 show results of the selective display of a patent portfolio with a system according to the invention.

FIG. 9 shows the display of a group of patent applications/patents 400 as basic objects 455 according to FIG. 7. To restrict the quantity of results of a user-defined search for the basic object type Patent applications/patents, as well as the selective choice by combinations 452 S-WT (company) and 454 S-OEK (company division), as selection criteria the agent 442, the priority year 444 and the status 446 were used. As an agent 442 Dr. Mustermann was selected and as status 446 “in force”. For the priority year 444, S-OEK 452 and S-WT 454 no selection was made, but “All” selected. Depending on which user 432 performs the display, the number of visible basic objects 455 is further restricted from the total number in 440 found according to the criteria, as a function of the user's access authorisation (see FIG. 7).

The selected and displayed patents 400 are shown with the title (object text 142 from FIG. 3) and some hierarchy-independent basic data 420 (patent committee area/month of meeting; 1st priority date and country, specialist area allocation in the Patent Committee, cancellation date), 442 agent and 412 (countries; inventor; accounts; decisions; products for which inventor royalty is paid (EVAG products)).

For the hierarchy-independent basic data 412 in FIG. 9 however the system only shows how many data are found in the associated list. The list itself with these basic data 412 can be retrieved separately for each Patent 400 via a drill-down menu 750 (FIG. 10).

If e.g. “Countries” is selected in the drill-down menu 750 in FIG. 10, a list is displayed of countries in which patent applications/patents exist on basic object 400 (see for example FIG. 11). Here further hierarchy-independent basic data then appear, such as the list of counties 412 and for these countries the basic data 413 “Due date for patent fees”, “Patent duration”, “Application number and date”, “Granting number and date”, “Patent expiry dates”, “Publication number and date”, “State of granting process” (application, examination request, patent), “Status” (X=cancelled, F=due), “Cancellation date”, information on whether objections or appeals have been submitted, and cancellation date. At the same time, the same selected basic data 420, 442 and the object text 142 appear as in the header in FIGS. 9 and 10.

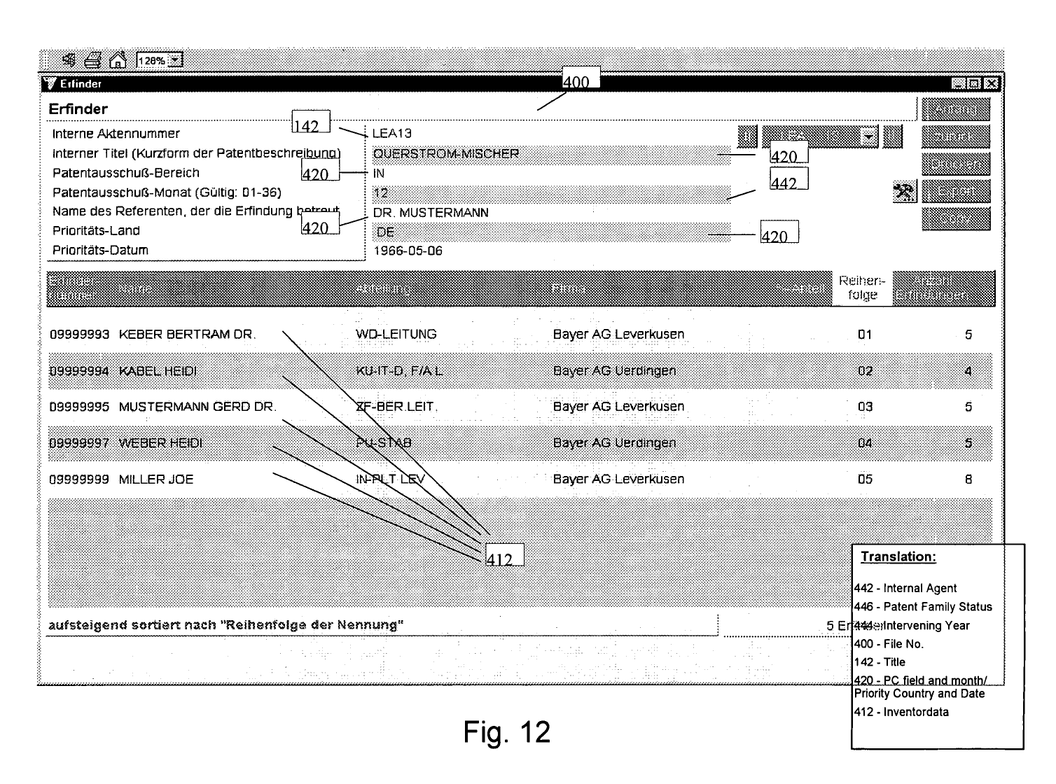

If e.g. “Inventor” is selected in the drill-down menu 750 in FIG. 10, a list appears with the inventors 412 belonging to the selected patent (FIG. 12). Allocated to each inventor is the number of patent applications/patents in which he is involved. This is given in the last column in FIG. 12. At the same time, the same selected basic data 420, 442 and the object text 142 appear as in the header in FIGS. 9, 10 and 11.

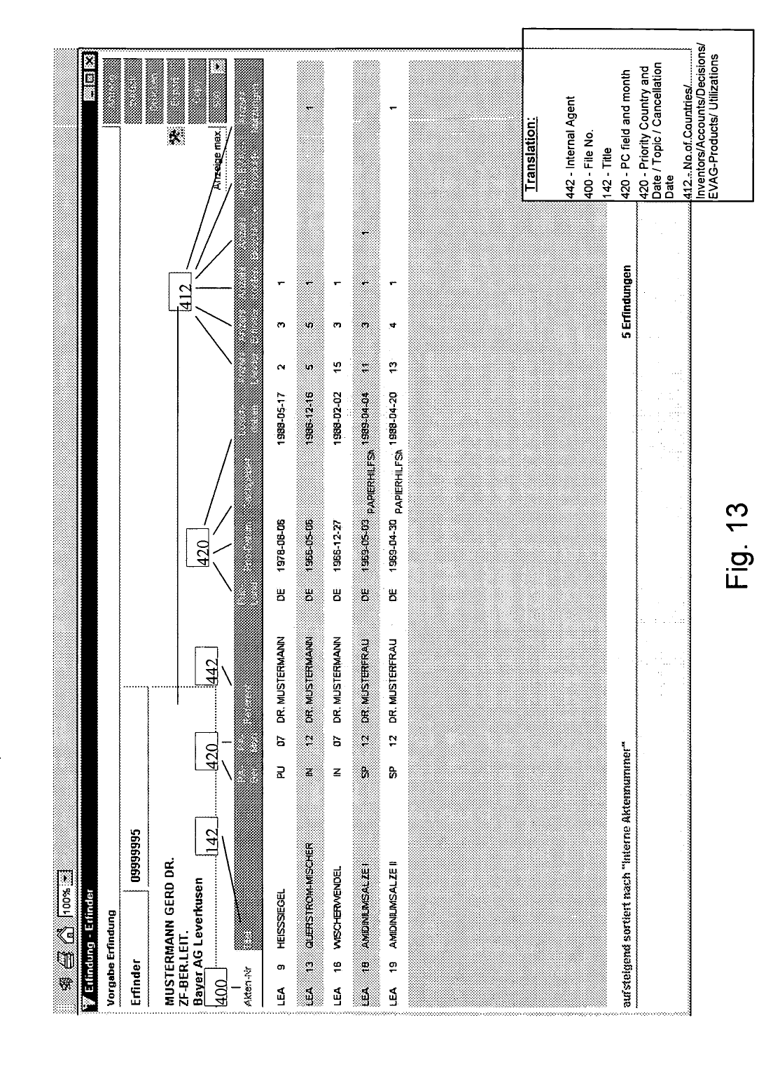

The display of the patents allocated to a selected inventor (Dr. Gerd Mustermann) is shown in FIG. 13 together with some basic data as in FIG. 9 or 10. To restrict the quantity of results of the user-defined search by the basic object type Patent applications/patents, here only the inventor 412 is used as the selection criterion.

1. System for displaying a portfolio comprising a computer-legible data memory with a database system
with stored therein basic objects (100, 400, 500), each of which is clearly linked to one or more basic data (120, 412, 420, 512, 520),
where the basic objects (100, 400, 500) are allocated to one or more structural units (152, 154, 150) in a multi-dimensional hierarchical model of a company or an institution (140), and
the structural units (152, 154, 150) are stored in a relational database, and the basic objects (100) allocated to the individual structural units (152, 154, 150) can be displayed with one or more basic data (120) selectively or as a whole.

2. System according to claim 1, characterised in that one or more users (432, 532) are stored in the database system and can each be allocated to one or more of the stored structural units (452, 454, 450; 552, 554, 550) and these users (432, 532) can selectively display only the basic objects (455, 555) belonging to the structural units to which these users (432, 532) are allocated.

3. System according to claim 1 or 2, characterised in that the basic data (120, 412, 420, 512, 520) are hierarchy-dependent and/or hierarchy-independent.

4. System according to any of claims 1 to 3, characterised in that at least one basic object (100, 400, 500) is linked to one or more other basic objects (100, 400, 500).

5. System according to any of claims 1 to 4, characterised in that various basic objects (100, 400, 500) are linked to the same hierarchy (140).

6. System according to any of claims 1 to 5, characterised in that the basic objects (100, 400, 500) are patent applications/patents (400), contracts (500) or products.

7. System according to any of claims 1 to 6, characterised in that the basic objects (100, 400, 500) are patent applications/patents (400) and the basic data (120, 412, 420) are priority dates, countries in which applications have been made and for these countries the application number and date, publication number and date, granting number and date, due date for patent fees, durations, patent expiry dates, examination request dates, information on whether objections or appeals have been submitted, cancellation date, applicant and/or inventor.

8. System according to any of claims 1 to 6, characterised in that the basic objects (100, 400, 500) are patent applications/patents (400) and the basic data (120, 412, 420) contain information on the organisation and charging of activities for patent applications/patents within the company or institution, such as decision bodies and their resolutions, internal decision dates, products for which inventor royalties are paid, accounts for charging of costs, competent patent attorney or agent, and/or status of the entire patent family (in force, expired, lapsed).

9. System according to any of claims 1 to 6, characterised in that the basic objects (500) are contracts, and the basic data (120, 512, 520) contain information on the contract type, licence type, contract partner, supplier/client, contract start, contract end, signature dates, object of the contract, contract status (e.g. in force, terminated), contract language, countries concerned.

10. System according to any of claims 1 to 6, characterised in that the basic objects (100) are products, and the basic data (120) contain information on the products such as turnover, profit.

11. System according to any of claims 1 to 10, characterised in that the multidimensional, hierarchical model reflects a science/technology-based structure and an economics-based structure of the company or institution.

12. System according to any of claims 1 to 11, characterised in that the computer-legible data memory is located in a central computer (10) which is connected with one or more user terminals (60, 70), which each have an input device and a display device to display the selected basic objects (100), so that data can be exchanged electronically between the central computer (10) and the user terminals (60, 70).
